(19) United States
(12) Patent Application Publication
(10) Pub. No.: US 2003/0225744 A1
(43) Pub. Date: Dec. 4, 2003

(54) Method, personal digital assistant, and computer-readable medium for exchange of information

(76) Inventor: Luke Waaler, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/157,270

(22) Filed: May 28, 2002

(51) Int. Cl. G06F 7/00

(52) U.S. Cl. 707/3

(57) ABSTRACT

A method of obtaining information by a personal digital assistant (PDA) comprising storing a record in a database of a first PDA, the record maintaining a first data element, transmitting an interrogation command to a second PDA, the interrogation command comprising a copy of the first data element, receiving a result signal by the first PDA, the result signal indicative of an interrogation performed by the second PDA on an interrogated database maintained thereby, and providing an indication, on an output device of the first PDA, of the result signal indicative of the occurrence of a correspondence between the first data element and a data element of the interrogated database is provided.

### TECHNICAL FIELD OF THE INVENTION

This invention relates to data storage and retrieval technologies and, more particularly, to a method, personal digital assistant, and computer-readable medium for exchanging of information.

### BACKGROUND OF THE INVENTION

Personal digital assistants (PDAs) were originally developed to facilitate storage and retrieval of personal information, such as business contact information, personal schedules and other information, to facilitate organization of a user thereof. APPLE COMPUTER, INC. manufactured one of the first PDAs commercially available. Other PDAs have since been introduced with varying levels of acceptance, and the usages thereof have been expanded. Modern PDAs are essentially small personal computers that may run word processing programs, facilitate communications such as email correspondence, run one or more of an array of personal organization utilities, and execute entertainment applications such as multimedia players and/or other applications. The functionality of a PDA may be expanded by performing data synchronization via an interface with a personal computer.

Notepads, contact organizers, and appointment utilities are commonly offered as standard features of modern PDAs. Contact organizers may be utilized to store names, addresses, phone numbers, email addresses, or other personal information of acquaintances, business associates, or other persons of interest, and provide a convenient storage and retrieval medium therefor. However, a contact organizer application run by a PDA requires manual entry of contact information by a user of the PDA. Typical PDAs have touch screen interfaces through which a user of the PDA may make data entry into a contact organizer application by stylus input. A handwriting recognition algorithm may be executed by the PDA to facilitate input of personal information and storage thereof with a set of records accessible or included within the contact organizer application. However, manual input of data via a stylus and touch screen is often tedious and subject to errors due to the limitations of a handwriting recognition algorithm. Furthermore, common handwriting recognition algorithms designed to be efficiently executed by the limited processing capabilities of a PDA require data entry to be performed in a shorthand notation comprised of a specialized alphabet recognizable by the handwriting recognition algorithm.

### SUMMARY OF THE INVENTION

Heretofore, PDAs have not offered the functionality of automatically obtaining personal information from persons of interest or persons having a common personal, biographical, professional, or other association. In accordance with an embodiment of the present invention, a method of obtaining information by a personal digital assistant (PDA) comprising storing a record in a database of a first PDA, the record maintaining a first data element, transmitting an interrogation command to a second PDA, the interrogation command comprising a copy of the first data element, receiving a result signal by the first PDA, the result signal indicative of an interrogation performed by the second PDA on an interrogated database maintained thereby, and providing an indication, on an output device of the first PDA, of the result signal indicative of the occurrence of a correspondence between the first data element and a data element of the interrogated database is provided.

In accordance with another embodiment of the present invention, a method of providing information by a personal digital assistant comprising receiving, by a first PDA, an interrogation command transmitted by a second PDA, the interrogation command comprising a first data element and interrogating a database maintained by the first PDA with the interrogation command, and providing an indication of a result of the interrogation on an output device is provided.

In accordance with another embodiment of the invention, a personal digital assistant for obtaining information comprising a processor, an input/output communication port operable to transmit data to an external database and receive information from the external database, an input/output device operable to receive input from a user of the PDA and provide output thereto, the input/output device operable to receive an interrogation request through interaction therewith by a user of the PDA, and a memory module maintaining a program and a first database therein, the processor and the program comprising logic to direct the processor to transmit an interrogation command to the external database via the input/output communication port, the interrogation command including a copy of a data element of a first record of the first database, the input/output communication port operable to receive a response comprising an indication of whether a correspondence between the interrogation command and the external database is determined, the program operable to invoke the input/output device and direct output thereto indicative of the response is provided.

In accordance with yet another embodiment of the invention, a personal digital assistant for providing information comprising a processor, an input/output communication port operable to receive and transmit data, an input/output device operable to receive input from a user of the PDA and provide output thereto, and a memory module maintaining a program and a database therein, the program comprising logic to direct the processor to process an interrogation command received by the input/output communication port and to interrogate the database with the interrogation command, the program further comprising logic to direct the processor to generate a result signal comprising an indication of whether a correspondence between the interrogation command and the database is determined and further comprising logic to output the result signal via the input/output communication port, the program operable to invoke the input/output device and direct output thereto indicative of the result signal is provided.

In accordance with yet another embodiment of the present invention, a system for obtaining information for display on a personal digital assistant comprising means for storing a first record of a first database on a first personal digital assistant, the first record maintaining a first data element, means for transmitting an interrogation command to a second personal digital assistant, the interrogation command including the first data element, means for receiving the interrogation command by the second personal digital assistant, means for interrogating a first record of a second database of the second personal digital assistant, the second record maintaining a second data element, and means for providing an indication of a result of the interrogation on an output device of at least one of the first personal digital assistant and the second personal digital assistant is provided.

In accordance with yet another embodiment of the present invention, a computer-readable medium having stored thereon a set of instructions to be executed, the set of instructions, when executed by a processor, cause the processor to perform a computer method of reading an interrogation command comprising a data element, interrogating a record of a database, providing an output indicative of results of the interrogation, and providing additional output indicative of the results of the interrogation upon authorization input by a user associated with the database is provided.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a block diagram illustrating a personal digital assistant in which an embodiment of the present invention may be used to advantage;

FIG. 2 is a block diagram illustrating arrays of records that may be stored in a database maintained in a memory of a personal digital assistant according to an embodiment of the present invention;

FIG. 3 is a block diagram illustrating an exemplary graphical user interface that may be provided by a contact organizer program upon execution thereof by a microprocessor and that may be displayed on an input/output device of a personal digital assistant according to an embodiment of the present invention;

FIG. 4 is a block diagram of a personal digital assistants in a configuration in which contact information may be exchanged therebetween according to an embodiment of the present invention; and

FIG. 5 is a flowchart of a contact organizer program processing routine that may facilitate data exchange between two or more personal digital assistants according to an embodiment of the present invention.

### DETAILED DESCRIPTION OF THE DRAWINGS

The preferred embodiment of the present invention and its advantages are best understood by referring to FIGS. 1 through 5 of the drawings, like numerals being used for like and corresponding parts of the various drawings.

In FIG. 1, there is a block diagram of a personal digital assistant (PDA) 10 that may comprise an algorithm that facilitates discovery and exchange of personal information. PDA 10 comprises a microprocessor 20, such as HITACHI's SH7709a, interconnected with one or more PDA 10 subsystems via a local interface 25, such as one or more buses. Microprocessor 20 may be interconnected to a non-volatile storage, such as a read only memory (ROM) 30, and/or a volatile storage, such as a semiconductor static random-access memory (RAM) 35, a dynamic random-access memory, a flash electrically-erasable programmable read only memory, and/or another volatile storage device, via interface 25. ROM 30 may be used to store computer executable instruction sets, such as an operating system, an address book application, or another program that is typically included onboard PDA 10 as a standard feature thereof.

User data, such as data entered through an input/output (I/O) device 40, such as a keyboard, a touch screen, and/or a keypad disposed on a display surface of PDA 10, and/or programs installed in the PDA by a user may be stored within RAM 35 and are retrievable therefrom by microprocessor 20. I/O device 40, such as a touch screen, may be utilized to accept input from a user and to provide output to the user as well. Input may be provided to I/O device by, for example, a stylus and a handwriting recognition algorithm maintained in ROM 30 or RAM 35 that is executable in microprocessor 20.

PDA 10 may further comprise one or more I/O ports 45, such as a serial port, a universal serial bus (USB), and/or another peripheral interconnect, that facilitates exchange of communications between PDA 10 and an external device, such as a personal computer, via a cable. I/O port 45 may be connected to a peripheral communication device such as an external cable or landline or a wireless modem that enhances the communication capabilities of PDA 10. In addition, PDA 10 may include one or more wireless communication ports, such as an infrared port 50 that includes an infrared transmitter and/or receiver, that facilitate exchange of information via infrared light to and/or from an infrared capable personal computer, PDA or another device. A wireless port 55 may be included within PDA 10 and optic communications, radio frequency (RF) communications, or other electromagnetic communications, may be exchanged between PDA 10 and another wireless device and/or terrestrial device, such as mobile terminals and/or computing devices interfacing with a wireless network such as a cellular telephone network.

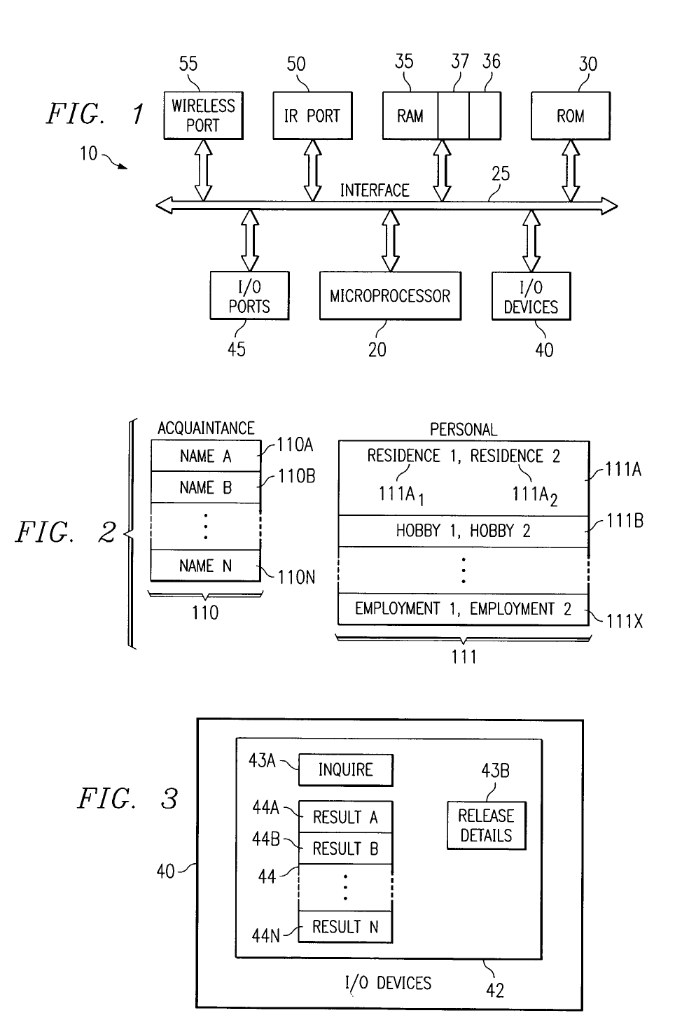

In FIG. 2, there is a simplified illustration of arrays 110-111 of respective records 110A-110N and 111A-111X that may be stored in a database 36 (FIG. 1) that may be maintained in RAM 35. Records 110A-110N may respectively comprise contact information, such as a name of an acquaintance, of a user of PDA 10. Records 111A-111X may respectively comprise personal information, such as one or more residences, hobbies, employment histories, or other information, of a user of PDA 10. Database 36 may be accessed by a contact organizer program 37 (FIG. 1) maintained in RAM 35 that is retrievable and executable by microprocessor 20 via interface 25. Alternatively, database 36 and contact organizer program 37 may be maintained in ROM 30.

Acquaintance information stored in records 110A-110N may be entered by a user, for example through stylus and touchscreen input or by entry through another I/O device 40. The number of records of array 110 may be expanded, for example, upon entry of additional acquaintances by the user. Likewise, personal information of the user may be entered through an I/O device 40 and the number of records of array 111 may be expanded upon entry of additional personal information. Each record 111A-111X may maintain one or more data elements. For example, a plurality of residence data elements 111A₁-111A₂ may be stored within record 111A. Respective data elements 111A₁-111A₂ may be separated by a delimiter within record 111A. Alternatively, multiple data elements having similar information, such as residential information, employment information, association information, hobby information, interests information, or another common attribute, may be stored in individual records of array 111.

Contact organizer program 37 facilitates discovery and exchange of information maintained within database 36 by the user with a user of another PDA having an instance of contact organizer program 37, or a compatible utility, run therefrom. In FIG. 3, there is a simplified illustration of an exemplary graphical user interface (GUI) 42 that may be provided by contact organizer program 37 upon execution thereof by microprocessor 20 and that may be displayed on I/O device 40, such as a touchscreen. GUI 42 may comprise one or more buttons 43A-43B and/or display panes 44 having one or more display elements 44A-44N that facilitate interaction with contact organizer program 37. Buttons 43A-43B, display elements 44A-44N, and/or other portions of GUI 42 may provide visual output to a user and may facilitate execution of event-driven routines, or procedures, of contact organizer program 37 by accepting input from the user of PDA 10 by interaction, such as stylus contact with I/O device 40 displaying GUI 42, therewith. Button 43A may accept input that invokes execution of an inquiry to a database of records onboard another PDA running a second instance of contact organizer program 37.

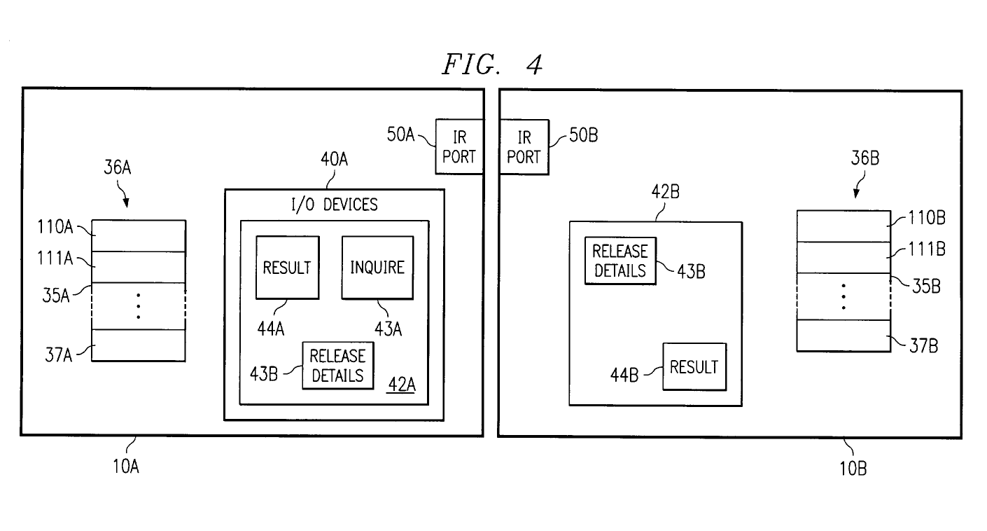

With reference to FIG. 4, there is shown a plan view of a PDA 10A and a PDA 10B in a configuration in which contact information may be exchanged therebetween according to an embodiment of the present invention. PDA 10A and PDA 10B respectively run an instance of contact organizer program 37A and 37B. Accordingly, each of PDAs 10A and 10B may maintain a respective database 36A and 36B maintained in RAM 35A and 35B. Databases 36A and 36B may maintain contact information and/or personal information of users of PDAs 10A and 10B. A user of PDA 10A may initiate interrogation of contact and/or personal information of another user operating PDA 10B through interaction with an instance of contact organizer program 37A executed by PDA 10A, for example by providing input to GUI 42A via an inquire button 43A or another GUI 42A element. Upon request for an interrogation supplied to contact organizer program 37A, for example by selection of inquire button 43A, an interrogation command may be transmitted to PDA 10B. For example, an interrogate routine of contact organizer program 37A may be invoked and/or actuation of transmittal circuitry, such as IR port 50A or another communication component or subsystem of PDA 10A operable to transmit a command to PDA 10B, may be directed by microprocessor 20 upon receipt of the request for interrogation thereby. PDA 10B receives, for example via IR port 50B, the interrogate command transmitted by PDA 10A and database 36B, or a portion thereof, may be interrogated by contact organizer program 37B in response thereto. Preferably, contact organizer program 37A and 37B maintain respective arrays of records 110A-110B and 111A-111B in a hierarchical configuration within database 36A and 36B such that one or more arrays, such as personal information array 111A and 111B maintained within a database 36A and 36B, respectively, is provided a greater level of security than another array(s) of records, such as an array of acquaintance information 110A and 110B, respectively.

An interrogate command transmitted from PDA 110A to another PDA may include information retrieved from database 36A, such as data elements of records 110A of acquaintances of the operator of PDA 110A issuing the interrogate command. The contents of acquaintance records maintained in array 110A may then be used as indices to database 36B by contact organizer program 37B upon reception of the interrogate command by PDA 110B. One or more arrays 110B and 111B, or a respective field thereof, maintained in database 36B may then be searched for correspondence with contents of the interrogate command. In the event of a correspondence, or match, between contents of the interrogate command and one or more arrays 110B and 111B searched therewith is identified, GUI 42A and/or 42B may provide a visual indication thereof to a user of PDA 10A and/or 10B, for example display of a interrogation result in pane 44A and/or pane 44B. Failure to identify a correspondence between the contents of the interrogate command and the contents of one or more arrays 110A and/or 111B may be indicated to a user of PDA 10A and/or 10B as well.

As mentioned hereinabove, respective arrays of records 110A-110B and 111A-111B may be maintained in a hierarchical configuration within database 36A and 36B such that one or more arrays, for example personal information array 111A and 111B maintained within a database 36A and 36B, is provided a greater level of security than another array(s) of records, such as an array of acquaintance information 110A and 110B. Preferably, GUI 42A and 42B may provide a release details button 43B₁ and 43B₂ that respectively invokes a procedure of contact organizer program 37A and 37B and actuates transmittal of secured information, such as personal information maintained in respective arrays 111A and 111B, to an interrogating PDA. For example, upon issue of an interrogation command by PDA 10A to 10B, contents of unsecured information maintained in database 36B may be searched and a correspondence therebetween may be indicated to users of PDA 10A and 10B via respective GUI 42A and 42B. Release details button 43B₁ may then be selected by a user of PDA 10B and secured information maintained in PDA 10B may be transmitted from PDA 10B to PDA 10A and displayed in pane 44A. Personal information displayed in pane 44A may then be saved by a user of PDA 10A within database 36A or, alternatively, may be discarded.

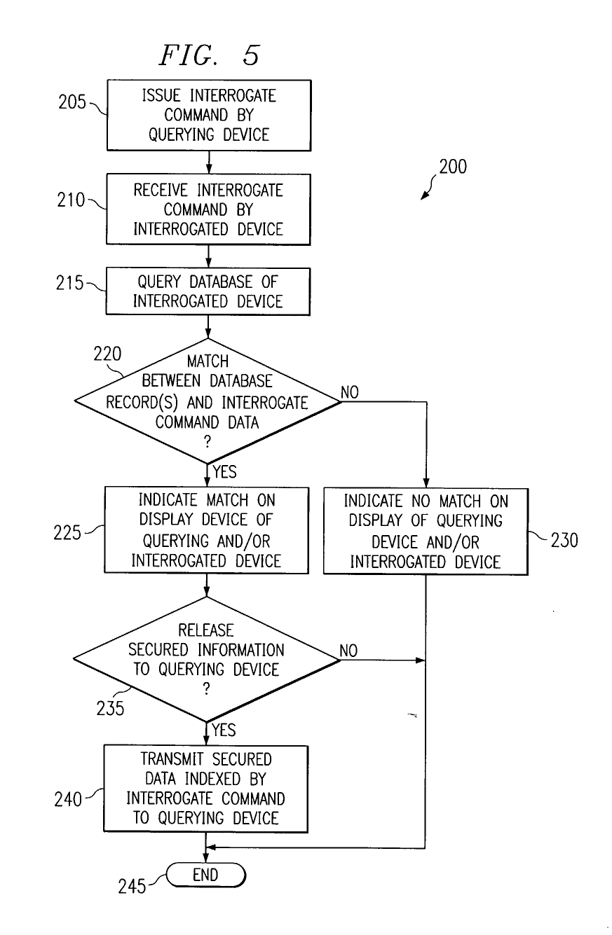

In FIG. 5, there is a flowchart 200 of a contact organizer program processing routine that may facilitate data exchange between two or more personal digital assistants according to an embodiment of the present invention. Elements of flowchart 200 may be executed on a querying PDA and/or an interrogated PDA. Processing of the organizer program is invoked upon issue of an interrogation command by a querying device (step 205), such as PDA 10A. The interrogation command is transmitted from the querying device and received by the interrogated device (step 210) and thereafter a database, or other record(s), is queried with contents of the interrogation command (step 215). An evaluation of whether a correspondence, or match, is made with contents of the interrogation command and any records of the interrogated database (step 220) is made. Failure to determine a match results in an indication thereof being provided on an output device, such as a display device, of the querying device and/or the interrogated device (step 230). Output by the querying device of an indication of failure to determine a correspondence between contents of the interrogation command and a record of the interrogated database is preceded by a requisite communication transmittal (not shown) from the interrogated device to the querying device. Thereafter, organizer application processing may end (step 245).

Upon a successful determination of a correspondence between the interrogation command and a record of the interrogated database, an indication of a successful correspondence may be provided on an output device of the interrogated device and/or the querying device (step 225). Output by the querying device of an indication of a successful determination of a correspondence between contents of the interrogation command and a record of the interrogated database is preceded by a requisite communication transmittal (not shown) from the interrogated device to the querying device. A release of secured information may then be evaluated (step 235) to determine whether secured information is to be released by the interrogated device and transmitted to the querying device. Invocation of a release of secured information may be performed, for example, by the user of the interrogated device issuing a command through interaction with an element of a graphical user interface of the interrogated device. Failure of determining a confirmation of a release of secured information results in organizer program processing flow terminating (step 245). Confirmation of a release of secured information results in transmission of secured information from the interrogated device to the querying device (step 240) and may be followed by organizer application termination (step 245).

Accordingly, a user of a PDA of the present invention may make inquiries of personal, biographical, professional, and/or other information with a user of another compatible PDA and obtain information therefrom in a technique that does not require manual entry of the information. Furthermore, according to an embodiment of the invention, a PDA may allow interrogation of secured personal information only upon release thereof by an operator of a PDA maintaining the secured information. The owner of the interrogating PDA and/or the interrogated PDA may be notified of commonalties in information, such as contact information, maintained thereby. While the exemplary configuration described provides for interrogation of unsecured and secured information between two PDAs, other arrangements are possible according to the teachings of the invention. For example, information maintained in a database of a PDA may be secured according to a security hierarchy that provides more than two levels of security. Each such level of secured information may individually require a release authorization by the user of the interrogated PDA. Furthermore, interrogation of secured information may be allowed after authorization by the user of the interrogated device to conserve processing resources of the interrogated PDA. Results of an interrogation of secured information may be reported to an interrogating PDA with, or alternatively distinct from, results of interrogations of non-secured information.

What is claimed is:

1. A method of obtaining information by a personal digital assistant (PDA), comprising:
storing a record in a database of a first PDA, the record maintaining a first data element;
transmitting an interrogation command to a second PDA, the interrogation command comprising a copy of the first data element;
receiving a result signal by the first PDA, the result signal indicative of an interrogation performed by the second PDA on an interrogated database maintained thereby; and
providing an indication, on an output device of the first PDA, of the result signal indicative of the occurrence of a correspondence between the first data element and a data element of the interrogated database.

2. The method according to claim 1, wherein receiving a result signal further comprises receiving the result signal indicative of an interrogation performed by the second PDA on a subset of data of the interrogated database.

3. The method according to claim 1, wherein receiving a result signal further comprises receiving a result signal indicative of an interrogation performed on unsecured records of the interrogated database.

4. The method according to claim 1, wherein receiving a result signal further comprises receiving the result signal indicative of an interrogation performed by the second PDA on a secured subset of data of the interrogated database.

5. The method according to claim 1, further comprising receiving a record of the interrogated database, the received record containing a data element having a correspondence with the first data element.

6. The method according to claim 5, further comprising writing, by the first PDA, the received record into the database of the first PDA.

7. A method of providing information by a personal digital assistant (PDA), comprising:
receiving, by a first PDA, an interrogation command transmitted by a second PDA, the interrogation command comprising a first data element; and
interrogating a database maintained by the first PDA with the interrogation command; and
providing an indication of a result of the interrogation on an output device.

8. The method according to claim 7, wherein interrogating a database further comprises interrogating a first subset of records of the database, the first subset unsecured.

9. The method according to claim 8, wherein interrogating a database further comprises interrogating a second subset of the database, the second subset secured.

10. The method according to claim 9, further comprising authorizing, by a user of the second PDA, release of secured information maintained in a second subset of the database.

11. The method according to claim 7, wherein providing an indication of a result further comprises providing an indication of whether a correspondence between the interrogation command and a record of the database was determined.

12. The method according to claim 11, wherein providing an indication further comprises transmitting the indication to the second PDA.

13. The method according to claim 7, further comprising:
determining a correspondence between the interrogation command and a record of the database; and
transmitting, to the second PDA, the record of the database determined to have a correspondence with the interrogation command.

14. A personal digital assistant (PDA) for obtaining information, comprising:
a processor;
an input/output communication port operable to transmit data to an external database and receive information from the external database;
an input/output device operable to receive input from a user of the PDA and provide output thereto, the input/output device operable to receive an interrogation request through interaction therewith by a user of the PDA; and
a memory module maintaining a program and a first database therein, the processor and the program comprising logic to direct the processor to transmit an interrogation command to the external database via the input/output communication port, the interrogation command including a copy of a data element of a first record of the first database, the input/output communication port operable to receive a response comprising an indication of whether a correspondence between the interrogation command and the external database is determined, the program operable to invoke the input/output device and direct output thereto indicative of the response.

15. The PDA of claim 14, wherein the first database comprises a plurality of records each comprising at least one data element.

16. The PDA of claim 15, wherein the interrogation command comprises copies of a respective plurality of data elements of one or more of the plurality of records.

17. The PDA of claim 14, wherein the response further comprises a record of the external database.

18. The PDA of claim 17, wherein the program further comprises logic to write the record of the external database to a second record of the first database.

19. A personal digital assistant (PDA) for providing information, comprising:
a processor;
an input/output communication port operable to receive and transmit data;
an input/output device operable to receive input from a user of the PDA and provide output thereto; and
a memory module maintaining a program and a database therein, the program comprising logic to direct the processor to process an interrogation command received by the input/output communication port and to interrogate the database with the interrogation command, the program further comprising logic to direct the processor to generate a result signal comprising an indication of whether a correspondence between the interrogation command and the database is determined and further comprising logic to output the result signal via the input/output communication port, the program operable to invoke the input/output device and direct output thereto indicative of the result signal.

20. The PDA of claim 19, wherein the database comprises a record having at least one data element.

21. The PDA of claim 19, wherein the interrogation command comprises a data element, the processor operable to determine a correspondence between the data element and a record of the database.

22. The PDA of claim 19, wherein the result signal comprises at least a portion of data maintained in the record.

23. The PDA of claim 19, wherein the program further comprises logic for receiving input from a user of the PDA via interaction with the input/output device, the program requiring an authorization input prior to output of the response.

24. The PDA of claim 19, wherein interrogation of the database is performed on a first subset of data maintained in the database, the first subset unsecured.

25. The PDA of claim 24, wherein the program further comprises logic for invoking output of the input/output device indicating the result signal and prompting a user of the PDA for authorization to interrogate a second subset of the database, interrogation of the second subset performed upon an authorization input made by the user.

26. A system for obtaining information for display on a personal digital assistant, comprising:
means for storing a first record of a first database on a first personal digital assistant, the first record maintaining a first data element;
means for transmitting an interrogation command to a second personal digital assistant, the interrogation command including the first data element;
means for receiving the interrogation command by the second personal digital assistant;
means for interrogating a first record of a second database of the second personal digital assistant, the second record maintaining a second data element; and
means for providing an indication of a result of the interrogation on an output device of at least one of the first personal digital assistant and the second personal digital assistant.

27. The system according to claim 26, wherein means for interrogating a first record of a second database further comprises means for interrogating a plurality of records of the second database, each of the plurality of records maintaining a respective data element.

28. The system according to claim 26, further comprising:
means for authorizing, by a user of the second personal digital assistant, release of secured information maintained in a record of the second database maintained by the second personal digital assistant; and
means for transmitting, by the second personal digital assistant, the secured information of the second database to the first personal digital assistant.

29. A computer-readable medium having stored thereon a set of instructions to be executed, the set of instructions, when executed by a processor, cause the processor to perform a computer method of:
reading an interrogation command comprising a data element;
interrogating a record of a database;
providing an output indicative of results of the interrogation; and
providing additional output indicative of the results of the interrogation upon authorization input by a user associated with the database.

30. The computer-readable medium according to claim 29, wherein interrogating a record of a database further comprises:
searching a field of the database with the data element; and
evaluating whether an element of the field matches the data element.

31. The computer-readable medium according to claim 29, wherein reading an interrogation command comprising a data element further comprises reading an interrogation command comprising a data element selected form the group consisting of residential information, employment information, association information, hobby information, and interests information.
